(19) United States
(12) Patent Application Publication
(10) Pub. No.: US 2015/0183110 A1
(43) Pub. Date: Jul. 2, 2015

(54) MARKING SYSTEM USING GRAVITY SYSTEM

(71) Applicants: Anna Stoklosa, Maple (CA); Franciszek Stoklosa, Maple (CA)

(72) Inventors: Anna Stoklosa, Maple (CA); Franciszek Stoklosa, Maple (CA)

(21) Appl. No.: 14/531,100

(22) Filed: Nov. 3, 2014

(30) Foreign Application Priority Data
Nov. 12, 2013 (CA) 2832558

(51) Int. Cl. B25H 7/04

(52) U.S. Cl. CPC B25H 7/045

(57) ABSTRACT

The present invention pertains generally to marking surfaces by using gravity system and marking object that is being placed in a marking tube and allowing by its gravity to touch the surface, predominantly to mark the surface. The marking tube is adjustable allowing the marking object to touch the surface accordingly; the marking tube is located on a supporting guide. Particularly, the present invention should and/or will be useful for marking any flooring surfaces and/or any other surfaces where applicable.

### FIELD OF THE INVENTION

The present invention pertains generally to marking surfaces by using gravity system and marking object. Particularly, the present invention relates to TOOL, METHOD AND MARKING SYSTEM of Canadian Patent No. 2,625,566, U.S. Pat. No. 8,127,457 B2, and can be used as said or with other devices to mark any surfaces where applicable.

### BACKGROUND OF THE INVENTION

In the field of marking and tracing surfaces we see many innovations that are patented and in use. Although, many ways are registered with office and tested by engineers, there are more ways to simplify the marking system. The MARKING SYSTEM USING GRAVITY SYSTEM has been engineered to suit a particular invention with marking/tracing contour system for a TOOL, METHOD AND MARKING SYSTEM of Canadian Patent No. 2,625,566, U.S. Pat. No. 8,127,457 B2. For a perfect performance of marking by using pen or marker, while marking on any type of surface, the ideal marking system had to be engineered. This simple but innovative gravity system works perfectly with the TOOL, METHOD AND MARKING SYSTEM of Canadian Patent No. 2,625,566, U.S. Pat. No. 8,127,457 B2.

The marking system encompasses a marking tube that is adjustable and of a specific weight to work with gravity. The marking tube is situated in the hole of a supporting guide. The marking tube is in shape of a tube where the bottom is closed leaving little space for a tip of a pen or marker to go through and the top is fully open to input the marker/pen. The marking tube is in similar visual orientation as a screw with nut. The nut adjusts the distance of the tube from the surface. Well adjusted marking tube with its gravity can allow marker or pen that is inside of marking tube, mark on even surfaces and on uneven surfaces. When working on uneven surface, the marker/pen will touch the surface letting the marking tube move up and down accordingly.

The background of marking instruments shows that most of them were used with springs to adjust the distance, while this invention is simply using its gravitational weight. Currently there is no device that with such simplicity will allow marking on even and uneven surface while not touching the pen or marker by hand and specifically for use with TOOL, METHOD AND MARKING SYSTEM of Canadian Patent No. 2,625,566, U.S. Pat. No. 8,127,457 B2.

The present invention pertains generally to marking surfaces by using gravity system and marking object that is being placed in a marking tube and allowing by its gravity to touch the surface, predominantly to mark the surface. The marking tube is adjustable allowing the marking object to touch the surface accordingly; the marking tube is located throughout the supporting guide. Particularly, the present invention should and/or will be useful for marking any flooring surfaces and/or any other surfaces where applicable.

### SUMMARY OF THE INVENTION

The present invention provides a system that allows marking surfaces by using simple method of gravity, marking tube and adjustments when marking The marking tube is adjustable allowing the marking object to touch the surface accordingly; the marking tube is located throughout the supporting guide and the adjustment part is located on the outside side of the marking tube to adjust to the required position. Particularly, the present invention is engineered to work perfectly with the TOOL, METHOD AND MARKING SYSTEM of Canadian Patent No. 2,625,566, U.S. Pat. No. 8,127,457 B2, and also can be used to other devices that mark accordingly.

Operating the MARKING SYSTEM USING GRAVITY SYSTEM, on surfaces will allow the user/performer to easily mark the surface:
Specifically with the use of the invention: TOOL, METHOD AND MARKING

SYSTEM of Canadian Patent No. 2,625,566, U.S. Pat. No. 8,127,457 B2;
Easy, simple system that can be used with other devices;
Gravity system that allows to mark the surface by using a regular pen or marker;
Gravity system that is adjusted to allow marking the uneven surface;

### DETAILED DESCRIPTION OF DRAWINGS

Features and advantages of the present invention can be understood in detail; a more particular description of the invention, briefly summarized beneath, may and will reference to the embodiments thereof that are illustrated in the appended drawings. It is to be noted, however, that the appended drawings illustrate the typical embodiments of this invention and are, therefore, not to be considered limiting of its scope, for the invention may admit to other equally effective embodiments.

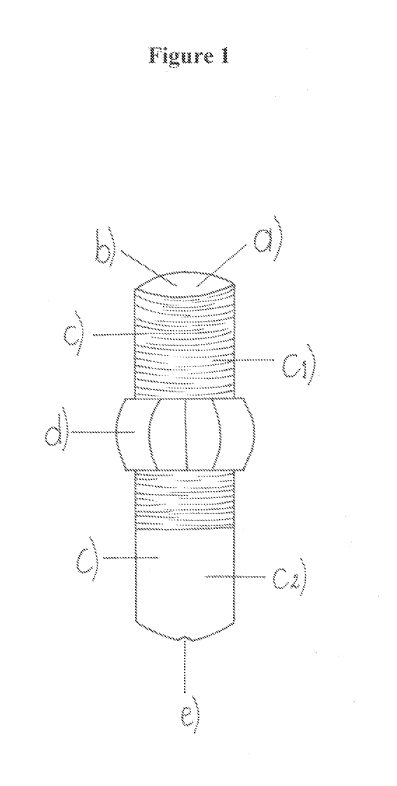

FIG. 1 Represents the MARKING SYSTEM USING GRAVITY SYSTEM, as a composition comprised of marking tube with nut:
a) pen holder hole
b) pen holder inside
c) pen holder outside
c1) threaded surface
c2) smooth surface
d) nut/screw nut
e) marker tip hole.

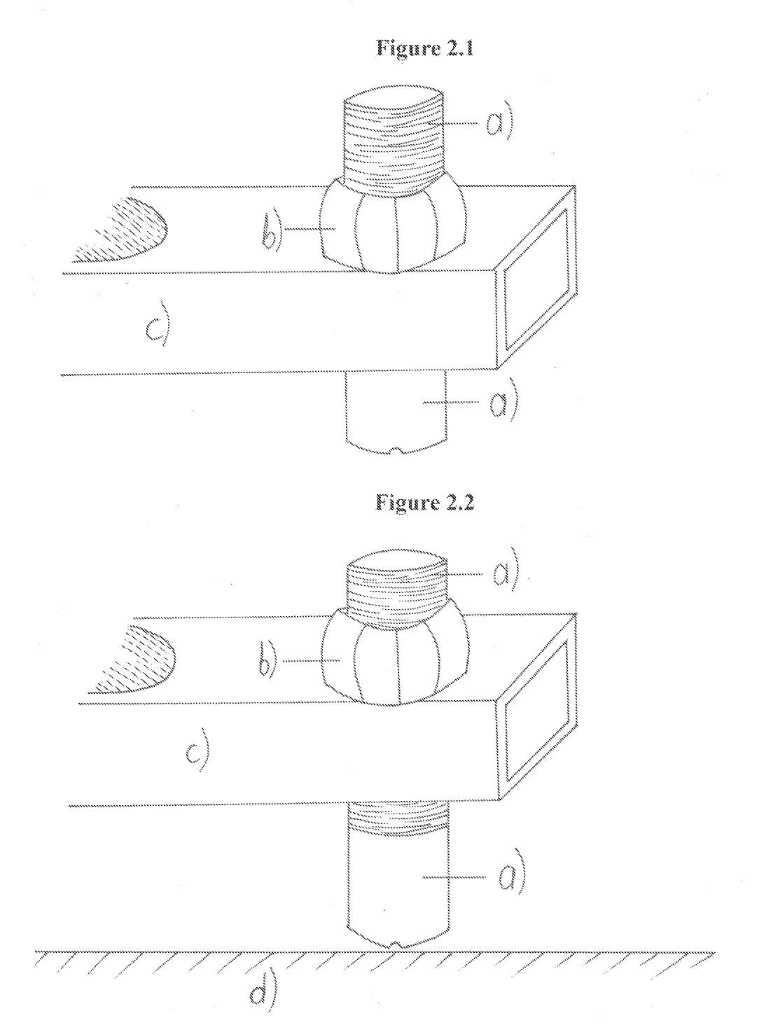

FIG. 2.1 Represents the MARKING SYSTEM USING GRAVITY SYSTEM, as composition comprised of marking pen/marker holder with nut, the supporting guide, in a higher positioned marking holder;
a) pen holder tube
b) nut/screw nut
c) supporting guide.

FIG. 2.2 Represents the MARKING SYSTEM USING GRAVITY SYSTEM, as composition comprised of marking pen/marker holder with nut, the supporting guide, in a lower positioned marking holder;
a) pen holder tube
b) nut/screw nut
c) supporting guide
d) surface.

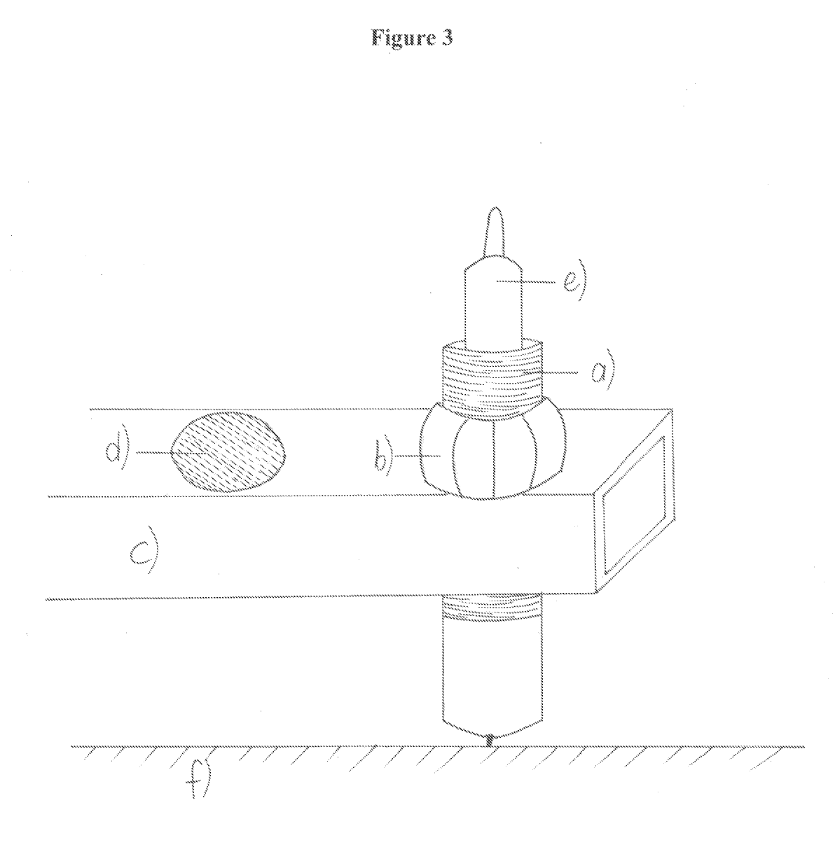

FIG. 3 Represents the MARKING SYSTEM USING GRAVITY SYSTEM, as a complete composition comprised of marking pen/marker holder with nut, the supporting guide, the pen/marker;
a) pen holder tube
b) nut/screw nut
c) supporting guide
d) supporting guide hole
e) rejectable marker/pen
f) surface.

### DETAILED DESCRIPTION OF THE INVENTION

Before explaining the present invention in details, it is to be understood that the invention is not limited to its application to the details of construction and arrangement of parts illustrated in the accompanying drawings. Moreover, it is to be understood that the phraseology and terminology employed herein is for the purpose of description and not of limitation.

In accordance with the present invention, and referring to FIG. 3, the composition comprises the complete invention, ready to be used when mounted to a marking device and particularly to a device of TOOL, METHOD AND MARKING SYSTEM of Canadian Patent No. 2,625,566, U.S. Pat. No. 8,127,457 B2; wherein the complete invention comprises: pen holder tube (FIG. 3a); nut/screw nut (FIG. 3b); supporting guide (FIG. 3c); supporting guide hole (FIG. 3d); rejectable marker/pen (FIG. 3e); surface (FIG. 3f).

Referring to FIG. 1, wherein the said marking holder is made from heavier material (metal, aluminum, fiber glass, etc.) due to its gravitational motion when placed into the supporting's guide hole (FIG. 3d). The marking holder looks like a tube with big opening on the top part (FIG. 1a) and with a little opening on the bottom of the holder (FIG. 1e), wherein the bottom must be formed angled and from inside must let/guide easily marker/pen into the marker tip hole (FIG. 1e). The marker holder has smooth surface inside (FIG. 1b); wherein the surface from outside (FIG. 1c) is smooth from the bottom (FIG. 1c2), and threaded from the smooth side to the rest of the top part (FIG. 1c1) allowing the nut/screw nut (FIG. 1d) for adjustments (FIG. 2.1) and (FIG. 2.2).

Referring to FIG. 2.1, wherein the said marking holder (FIG. 2.1a) is situated inside the supporting guide hole (FIG. 3d) and is in a higher position, wherein the threaded surface (FIG. 1c1) and in particular the top part is bigger than if in lower position (FIG. 1c2). Predominantly the screw (FIG. 2.1b) is the adjustment key allowing the marking holder to be in said position. The screw is blocking the marking holder to go through the supporting guide's hole down, wherein can easily go the other direction/upwards; moreover, the marking holder is not mounted to the supporting guide (FIG. 2.1c) and the marking holder can be moved to a different hole (FIG. 3d).

Referring to FIG. 2.2, wherein the said marking holder (FIG. 2.2a) is situated inside the supporting guide hole (FIG. 3d) and is in a lower position, wherein the threaded surface (FIG. 1c1) and in particular the top part is smaller than if in higher position (FIG. 1c2). Predominantly the screw (FIG. 2.2b) is the adjustment key allowing the marking holder to be in said position. The screw is blocking the marking holder to go through the supporting guide's hole down, wherein can easily go the other direction/upwards ; moreover, the marking holder is not mounted to the supporting guide (FIG. 2.2c) and the marking holder can be moved to a different hole (FIG. 3d). Moreover, when in lower position, and working on uneven surfaces where the distance between supporting guide and surface is shorter than the inputted marking holder, and because the marking holder is not mounted it moves upwards but when the surface suddenly becomes larger than the size of marking tube in position, the gravity will bring the marking holder down to the surface to touch the surface accordingly (FIG. 2.2d); therefore, every surface is touched by the marking object to acquire noticeable contour lines for an easy and convenient cut.

What is claimed is:

1. MARKING SYSTEM USING GRAVITY SYSTEM, wherein said composition comprises a manually controlled system for the reason of marking surfaces when using with the TOOL, METHOD AND MARKING SYSTEM of Canadian Patent No. 2,625,566, U.S. Pat. No. 8,127,457 B2, or other surfaces when used with combination of other devices, wherein said composition comprises:
a) a guide comprising: a guide track with holes to provide a secure storage of the marking tube, wherein the holes can be of any shape that corresponds with the marking tube;
b) a movable marking assembly comprising: a marking tube, wherein the marking tube is of a shape of screw that comprehends two surfaces from outside: the smooth surface and threaded surface; the marking tube has an opening from the top to input the marker and an minimal opening from the bottom to let out the tip of the marker; the marking tube is long enough to hold marker and correspond with the device; nut/screw nut that is located outside on the marking tube to adjust/to move the marking tube's position when placed in a supporting guide hole;

2. A method of using marking apparatus of claim 1, wherein the supporting guide is mounted to said apparatus or any other marking apparatus, wherein the supporting guide has holes for the reason of carriage and moving the measuring tube from a hole to the working hole, to obtain a different distance; the marking tube is located inside the supporting guide's hole and is adjusted by using nut/screw nut, wherein such nut is located on the outside of the marking tube; the marking tube works with gravity letting the marking tube straight down; the nut/screw nut works as adjustments and blocks the marking tube from falling through the supporting guide's hole down; the marking tube is a carriage of any marker that is compatible with the marking surfaces, wherein the marker is inputted inside the marking tube where the tip of a marker is outside the marking tube from the bottom's side of the marking tube; wherein the marking system is operated manually.
